(19) United States
(12) Patent Application Publication
(10) Pub. No.: US 2019/0305875 A1
(43) Pub. Date: Oct. 3, 2019

(54) RATE SEARCH BASED ON RECEIVED SIGNAL STRENGTH MEASUREMENT FROM BEAMFORMING

(71) Applicant: QUALCOMM Incorporated, San Diego, CA (US)

(72) Inventor: Qi Xue, San Diego, CA (US)

(21) Appl. No.: 15/937,747

(22) Filed: Mar. 27, 2018

(51) Int. Cl. H04L 1/00; H04B 7/06; H04B 7/0456

(52) U.S. Cl. CPC H04L 1/0003; H04L 1/0009; H04L 1/0026; H04B 7/0456; H04B 7/0617

(57) ABSTRACT

This disclosure provides systems, methods, and apparatus, including computer programs encoded on computer storage media, for performing an optimized rate search process. In one aspect, a first device may determine a signal strength measurement based on a result of a beamforming process. The first device may determine the signal strength measurement associated with a transmission sector selected based on a sector level sweep of the beamforming process. The first device may determine a modulation and coding scheme (MCS) for transmissions from the first device to a second device based, at least in part, on the signal strength measurement determined from the beamforming process. In one aspect, the first device may determine the MCS without using probing messages during the rate search process. In one aspect, the first device may determine an initial MCS based on the signal strength measurement, and determine whether to select or change the initial MCS.

### TECHNICAL FIELD

This disclosure relates generally to the field of communication systems, and more particularly to rate search techniques in a wireless local area network (WLAN).

### DESCRIPTION OF THE RELATED TECHNOLOGY

In a Wireless Local Area Network (WLAN), a first device may perform an association process with a second device to establish a communication link between the first device and the second device. The first device then performs a beamforming process and a rate search (or rate adaptation) process. The first device performs the rate search process to determine which modulation and coding scheme (MCS) to use for the communications from the first device (which may referred to as the transmitting device) to the second device (which may be referred to as the receiving device). Traditional rate search processes are typically time consuming and introduce a significant delay in selecting the MCS. This delay may slow down time-sensitive applications, such as video streaming or virtual reality applications.

### SUMMARY

The systems, methods, and devices of this disclosure each have several innovative aspects, no single one of which is solely responsible for the desirable attributes disclosed herein.

One innovative aspect of the subject matter described in this disclosure can be implemented by a first device for performing a rate search process. The first device may receive a result of a beamforming process from a second device, where the result of the beamforming process includes a signal strength measurement. The first device may determine a modulation and coding scheme (MCS) for transmissions from the first device to the second device based, at least in part, on the signal strength measurement determined from the beamforming process.

In some implementations, the first device may perform a sector level sweep (SLS) of the beamforming process. The first device may receive a result of the sector level sweep of the beamforming process from the second device, where the result of the sector level sweep includes the signal strength measurement and a transmission sector identifier. The device may select a first transmission sector from a plurality of transmission sectors based on the transmission sector identifier. The device may determine the signal strength measurement associated with the first transmission sector based on the result of the SLS of the beamforming process.

In some implementations, the first device may determine the MCS that is associated with the signal strength measurement based on an MCS table. The first device may select the MCS that is associated with the signal strength measurement for transmissions from the first device to the second device.

In some implementations, the first device may perform the rate search process after receiving the result of the beamforming process from the second device. The result of the beamforming process may include the signal strength measurement. The first device may determine the MCS based, at least in part, on the signal strength measurement determined from the beamforming process and without using probing messages during the rate search process. The first device may select the MCS that is associated with the signal strength measurement for transmissions from the first device to the second device.

In some implementations, the first device may determine the signal strength measurement is within a first signal strength range of a plurality of signal strength ranges. The first signal strength range may be associated with a first MCS. The first device may select the first MCS associated with the first range as an initial MCS. The first device may transmit a first probing message to the second device using the initial MCS. The first device may determine whether to select or change the initial MCS based on one or more feedback messages received from the second device.

Another innovative aspect of the subject matter described in this disclosure can be implemented in a first device comprising a processor and memory having instructions stored therein which, when executed by the processor, may cause the first device to receive a result of a beamforming process from a second device, where the result of the beamforming process including a signal strength measurement, and determine an MCS for transmissions from the first device to the second device based, at least in part, on the signal strength measurement determined from the beamforming process.

Another innovative aspect of the subject matter described in this disclosure can be implemented in a first device comprising means for performing a sector level sweep of a beamforming process, means for receiving a result of the sector level sweep of the beamforming process from a second device, the result of the sector level sweep including an indication of a first transmission sector and a signal strength measurement, means for selecting the first transmission sector from a plurality of transmission sectors based on the result of the sector level sweep of the beamforming process, means for determining the signal strength measurement associated with the first transmission sector based on the result of the sector level sweep of the beamforming process, and means for determining an MCS for transmissions from the first device to the second device based, at least in part, on the signal strength measurement determined from the sector level sweep of the beamforming process.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example diagram of a WLAN including a first WLAN device and a second WLAN device that can implement an optimized rate search process.

FIG. 2 depicts a diagram of example messages that may be transmitted by the WLAN devices during a beamforming process.

FIG. 3 shows an example message flow diagram of the WLAN devices implementing the optimized rate search process.

FIG. 4 shows an example flowchart of a WLAN device implementing the optimized rate search process.

FIG. 5 shows an example message flow diagram of WLAN devices implementing the optimized rate search process that determines an initial or starting MCS.

FIG. 6 shows an example flowchart of a WLAN device implementing the optimized rate search process that determines an initial or starting MCS.

FIG. 7 shows a continuation of the example flowchart of FIG. 6 for implementing the optimized rate search process.

FIG. 8 shows a block diagram of an example electronic device for implementing aspects of this disclosure.

Like reference numbers and designations in the various drawings indicate like elements.

### DETAILED DESCRIPTION

A local area network (LAN) (sometimes also referred to as a wireless local area network, or WLAN) in a home, apartment, business, or other area may include multiple WLAN devices, such as one or more access points (APs) and one or more stations (STAs). The WLAN may provide access to a broadband network. A gateway device, such as a central access point (CAP) or router, may provide access to the broadband network. For example, the gateway device can couple to the broadband network through a cable, a fiber optic, a power line, or digital subscriber line (DSL) network connection. STAs in the network can establish a wireless association (also referred to as a communication link, wireless connection, or the like) with an AP to access the broadband network via the gateway device. A STA can also perform a wireless association process to establish a peer-to-peer link with another STA. The wireless association process may be performed in accordance with an association protocol implemented by the APs and the STAs (such as an association protocol defined in the IEEE 802.11 standards). The WLAN devices may operate on an operating channel within one or more frequency bands, such as the 2.4 GHz, 5.0 GHz, and 60 GHz frequency bands. Each frequency band may include multiple channels, and the WLAN may select one of the channels as the operating channel for the established communication link.

A first WLAN device (which may also be referred to as the transmitting WLAN device) may performs a wireless association process with a second WLAN device (which may also be referred to as the receiving WLAN device) to establish a communication link between the devices. After performing the wireless association process, the first WLAN device may perform a beamforming process with the second WLAN device. During a sector level sweep (SLS) of the beamforming process, the antennas of the WLAN devices can transmit in various directions via predefined transmission beams or sectors. The first WLAN device can transmit an SLS message via each of the transmission beams or sectors to the second WLAN device to determine which transmission beam or sector is associated with the direction that is closest to the location of the second WLAN device. The first WLAN device may receive one or more SLS messages from the second WLAN device indicating which transmission beam or sector provided the best quality signal (e.g., the strongest signal with highest signal strength) to the second WLAN device. The first WLAN device can select the transmission beam or sector when communicating with the second WLAN device and focus a greater percentage of the energy or power of the transmission in the selected transmission beam or sector. For example, WLAN devices that implement IEEE 802.11ad protocols may operate in the 60 GHz frequency band in some situation and may perform the beamforming process. The high operating frequency associated with the 802.11ad protocols can introduce attenuation and result in high path loss. Performing the beamforming process to focus a greater percentage of the energy of a transmission in a particular beam or sector can compensate for the expected attenuation and high path loss when operating in the 60 GHz frequency band.

After performing the beamforming process, the first WLAN device may perform a rate search (or rate adaptation) process to select one of the available modulation and coding schemes (MCSs) for communications from the first WLAN device to the second WLAN device. Typically, a rate search process involves the first WLAN device testing or probing each of the available MCSs by sending probing messages. The probing messages may be used to determine whether the transmission based on the selected MCS meets a packet error rate (PER) requirement. WLAN devices typically test each MCS in numerical order, starting with the lowest MCS in an MCS index, which is MCS 0. For example, after sending the probing message using MCS 0, and receiving a response message from the second device, the first WLAN device typically sends a probing message using MCS 1, and so on. After testing each of the available MCSs, the first WLAN device may select the MCS with the highest data rate that meets the PER requirements. Thus, traditional rate search processes may test each MCS from the lowest MCS to the highest MCS to select the MCS to use for transmissions from the first WLAN device to the second WLAN device.

Performing a traditional rate search process that steps through each available MCS to determine which MCS to select for the transmissions introduces a significant delay in completing the rate search process. The delay introduced by the rate search process can significantly slow down time-sensitive transmissions for applications such as video streaming applications and virtual reality applications. Also, the traditional beamforming and rate search processes are typically independent of one another. In other words, the transmission beam or sector and other information derived from the beamforming process is not used in the rate search process to select the MCS. In accordance with this disclosure, these potential disadvantages of traditional beamforming and rate search processes may be overcome by an optimized rate search process that uses a signal strength report from the beamforming process to efficiently determine the MCS.

In some implementations, the first WLAN device can implement an optimized rate search process that is faster and more efficient than the traditional rate search process. During the optimized rate search process, the first WLAN device may use a signal strength measurement that is determined during the SLS of the beamforming process to select the MCS for transmissions from the first WLAN device to the second WLAN device.

In some implementations, the first WLAN device may receive one or more SLS messages from the second WLAN device that indicate the result of the beamforming process. For example, the first WLAN device may receive one or more SLS feedback messages that include a transmission sector identifier (or sector ID) and a signal strength measurement. The first WLAN device may select one of the transmission sectors based on the transmission sector identifier that is included in the result of the beamforming process. The first WLAN device may also determine the signal strength measurement that is associated with the selected transmission sector, which is also included in the results of the beamforming process. The signal strength measurement may indicate the signal strength that was measured by the second WLAN device (and reported to the first WLAN device) when the first WLAN device transmitted the SLS message using the corresponding transmission sector. The signal strength measurement may be a signal-to-noise ratio (SNR) or a received signal strength indicator (RSSI). The first WLAN device can use the signal strength measurement to determine which MCS to use for transmissions from the first WLAN device to the second WLAN device.

In some implementations, first WLAN device may directly determine the MCS based on the signal strength measurement that was obtained from the beamforming process and without sending probing messages during the rate search process. For example, the first WLAN device may determine the MCS that is associated with the signal strength measurement based on an MCS table that associates MCSs to signal strength measurements, as will be further described below.

In some implementations, the first WLAN device may determine an initial or starting MCS based on the signal strength measurement that was obtained from the beamforming process. The first WLAN device may then determine whether to select or change the initial MCS based one or more feedback messages received from the second WLAN device during the rate search process, as will be further described below.

Particular implementations of the subject matter described in this disclosure can be implemented to realize one or more of the following potential advantages. The optimized rate search process may reduce the amount of time that is needed to select an MCS for transmissions between WLAN devices. For example, the signal strength measurement that is determined from the beamforming process can be used to directly select the MCS for the transmissions and without having to send probing messages during the rate search process. Also, when the signal strength measurement is used to determine an initial or starting MCS, the number of probing messages that are transmitted is substantially reduced, which reduces the time to complete the rate search process. Eliminating the use of probing messages or reducing the number of probing messages that are sent in the WLAN during the rate search process may both reduce the time to complete the rate search process and reduce network traffic, which can help prevent network congestion. Furthermore, the optimized rate search process increases efficiency by using the signal strength measurement derived during the beamforming process to reduce the time to complete the rate search process.

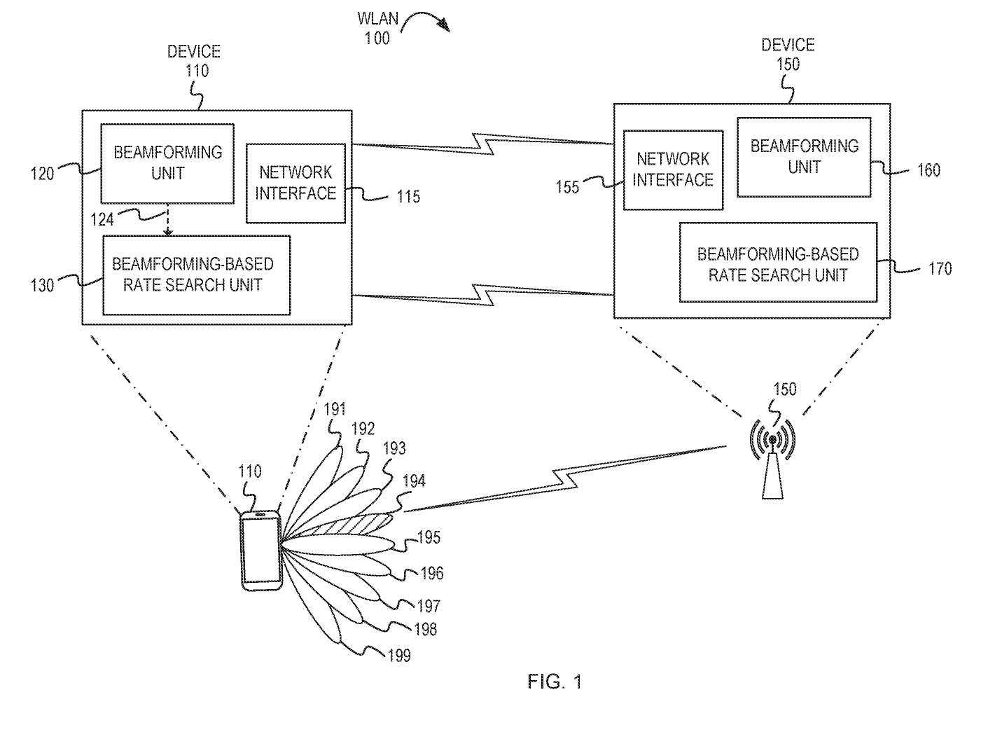

FIG. 1 shows an example diagram of a WLAN including a first WLAN device and a second WLAN device that can implement the optimized rate search process. The WLAN 100 may include at least device 110 and device 150. The devices 110 and 150 may be various types of WLAN devices that support and implement protocols defined in the IEEE 802.11 standards. For example, the devices 110 and 150 may be mobile phones, tablet computers, laptop computers, wearable devices, gaming consoles, televisions, access points (APs), smart appliances, etc. In some implementations, both of the devices 110 and 150 are stations (STAs) in the WLAN that are capable of establishing a peer-to-peer communication link. For example, both of the devices 110 and 150 may be portable devices (e.g., mobile phones, tablet computers, etc.). In another example, the device 110 may be a portable or wearable device and the device 150 may be a gaming console or television set. In some implementations, the device 110 may be a STA and the device 150 may be an AP in the WLAN. In accordance with the IEEE 802.11 standards, the devices 110 and 150 may support various frequency bands, such as the 2.4 GHz, 5.0 GHz, and the 60 GHz frequency bands. For example, in addition to supporting the 2.4 GHz and 5.0 GHz frequency bands, the devices 110 and 150 may implement IEEE 802.11ad protocols that support the 60 GHz frequency band.

As illustrated, the STA 110 may include a network interface 115, a beamforming unit 120, and a beamforming-based rate search unit 130. The network interface 115 may be included in a communication module of the device 110 and is representative of the one or more modems, one or more antennas, analog front end (AFE), and other network interface related components of the device 110. The beamforming unit 120 and the beamforming-based rate search unit 130 also may be included in the communication module of the device 110 and, in some implementations, may be implemented by one or more processors of the communication module. The device 150 may include a network interface 155, a beamforming unit 160, and a beamforming-based rate search unit 170. The network interface 155 may be included in a communication module of the device 150 and is representative of the one or more modems, one or more antennas, AFE, and other network interface related components of the device 150. The beamforming unit 160 and the beamforming-based rate search unit 170 also may be included in the communication module of the device 150 and, in some implementations, may be implemented by one or more processors of the communication module. The devices 110 and 150 may use the corresponding beamforming unit and beamforming-based rate search unit to implement the optimized rate search process.

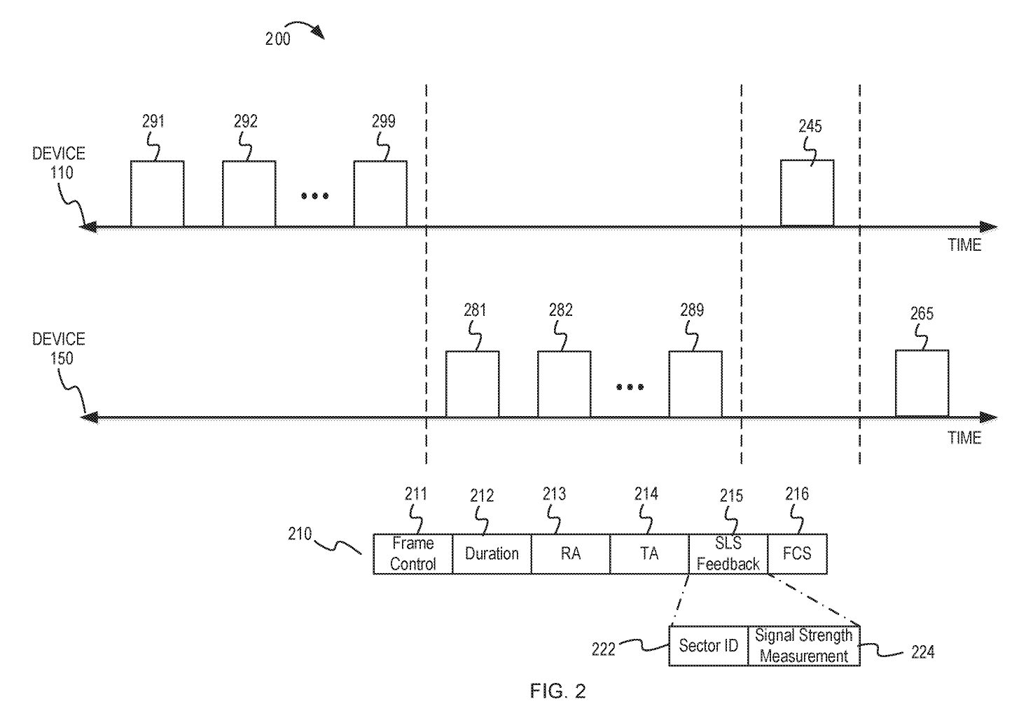

In some implementations, the device 110 may initiate a wireless association process with the device 150 to establish a communication link with the device 150. The device 110 may also be referred to as the transmitting device, transmitting WLAN device, or initiator device. The device 150 may also be referred to as the receiving device, receiving WLAN device, or responder device. After the devices 110 and 150 perform a wireless association process, the beamforming unit 120 of the device 110 may initiate a beamforming process with the device 150. A sector level sweep (SLS) of the beamforming process allows the device 110 to determine approximately in what direction the device 150 is located with respect to the device 110, since the device 150 can be located in any direction within the range of the device 110. The antennas of the device 110 can transmit in various directions via predefined transmission sectors (which may also be referred to as transmission beams) during the SLS. For example, the device 110 can transmit an SLS message via each of the transmission sectors 191-199. The SLS message transmitted by the device 110 may also be referred to as a sector sweep (SS) message or an initiator sector sweep (ISS) message. As shown in FIG. 1, each transmission sector transmits in a direction that is different than the other transmission sectors, such that collectively the transmission sectors 191-199 transit in various directions within the range of the device 110. During the SLS of the beamforming process, the device 110 can transmit an SLS message via each of the transmission sectors 191-199 to the device 150 to determine which transmission sector is associated with the direction that is closest to the location of the device 150. The beamforming unit 160 of the device 150 can respond to the device 110 with one or more SLS messages that indicate the transmission sector that provided the best quality signal (e.g., the strongest signal with highest signal strength) to the device 150, as will be further described in FIG. 2. The one or more SLS messages transmitted by the device 150 may also be referred to as sector sweep (SS) messages or responder sector sweep (RSS) messages. For instance, in the example shown in FIG. 1, the transmission sector 194 transmits the SLS message in the direction of the device 150. The transmission sector 194 may transmit the best quality signal compared to the other transmission sectors, and thus the device 150 may indicate in the one or more SLS messages that the transmission sector 194 provided the best quality signal. Based on the one or more SLS messages received from the device 150, the beamforming unit 120 of the device 110 may select one of the transmission sectors (e.g., transmission sector 194). When communicating with the device 150, the device 110 can focus a greater percentage of the energy or power of the transmission via the selected transmission sector. The device 150 may also indicate a signal strength measurement associated with the selected transmission sector in the one or more SLS messages. In some implementations, the device 150 may indicate the result of the SLS of the beamforming process in the one or more SLS messages that are transmitted to the device 110, where the one or more SLS messages include an indication of the selected transmission sector (e.g., the sector ID) and the signal strength measurement associated with the selected transmission sector.

In some implementations, after performing the beamforming process, the beamforming-based rate search unit 130 of the device 110 may perform the optimized rate search (or rate adaptation) process. The beamforming-based rate search unit 130 may determine the result of the SLS of the beamforming process from the one or more SLS messages received from the device 150. As described above, the beamforming unit 120 may select one of the transmission sectors based on the one or more SLS messages received from the device 150. The beamforming-based rate search unit 130 may determine the signal strength measurement associated with the selected transmission sector that was indicated in the one or more SLS messages. In some implementations, the beamforming unit 120 may provide the signal strength measurement (which was included in the one or more SLS messages) to the beamforming-based rate search unit 130, as illustrated by optional line 124. In some implementations, the beamforming unit 120 may store the signal strength measurement in memory and the beamforming-based rate search unit 130 may retrieve the signal strength measurement from memory when performing the rate search process. The signal strength measurement may be a signal-to-noise ratio (SNR) or a received signal strength indicator (RSSI). The beamforming-based rate search unit 130 may use the signal strength measurement to select one of the available MCS for the transmissions from the device 110 to the device 150. As described below, the beamforming-based rate search unit 130 of the device 110 may use one of at least two different techniques to select the MCS based on the signal strength measurement.

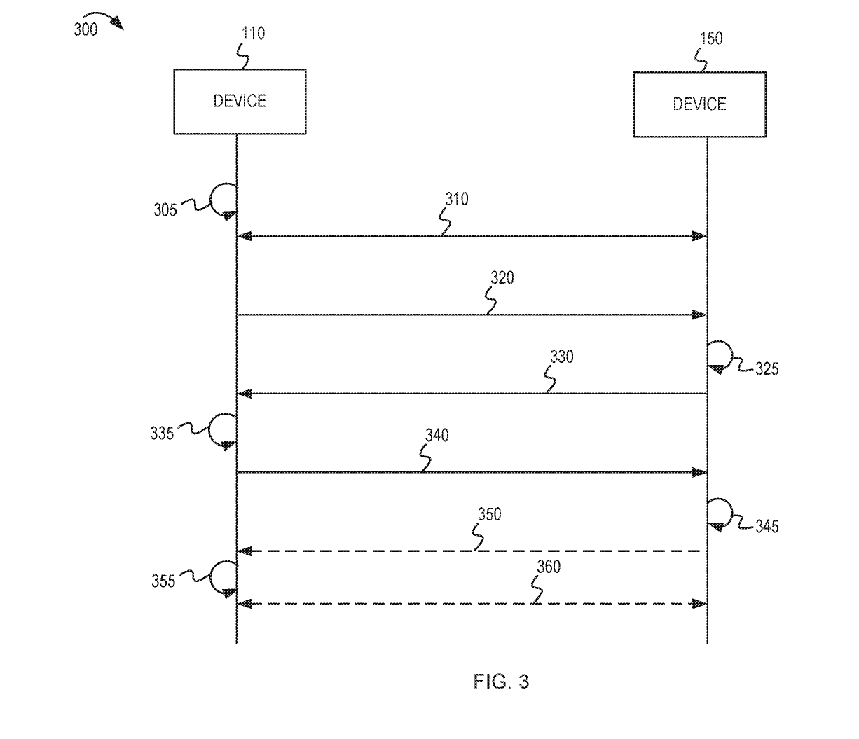

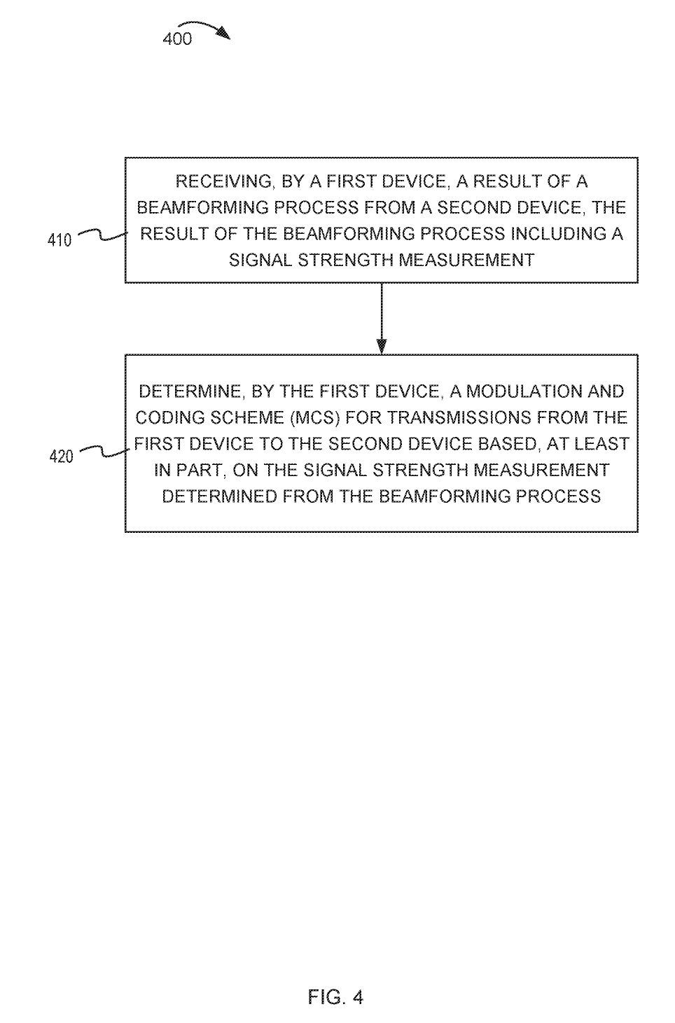

In some implementations, the beamforming-based rate search unit 130 of the device 110 may directly determine the MCS based on the signal strength measurement obtained from the beamforming process and without sending probing messages during the rate search process. The device 110 may determine the MCS based on the signal strength measurement and an MCS table that lists each of the available MCSs with various parameters that are associated with each MCS (including the signal strength associated with each MCS). For example, the device 110 may access the MCS table and select the MCS that is associated with a signal strength value that is closest to the signal strength measurement, as will be further described below in FIGS. 3 and 4. The device 110 may then use the selected MCS for transmissions from the device 110 to the device 150. In some implementations, when the device 110 implements this rate search technique for directly determining the MCS, beamforming-based rate search unit 130 may disable probing messages (and the corresponding PER checks) during the rate search process.

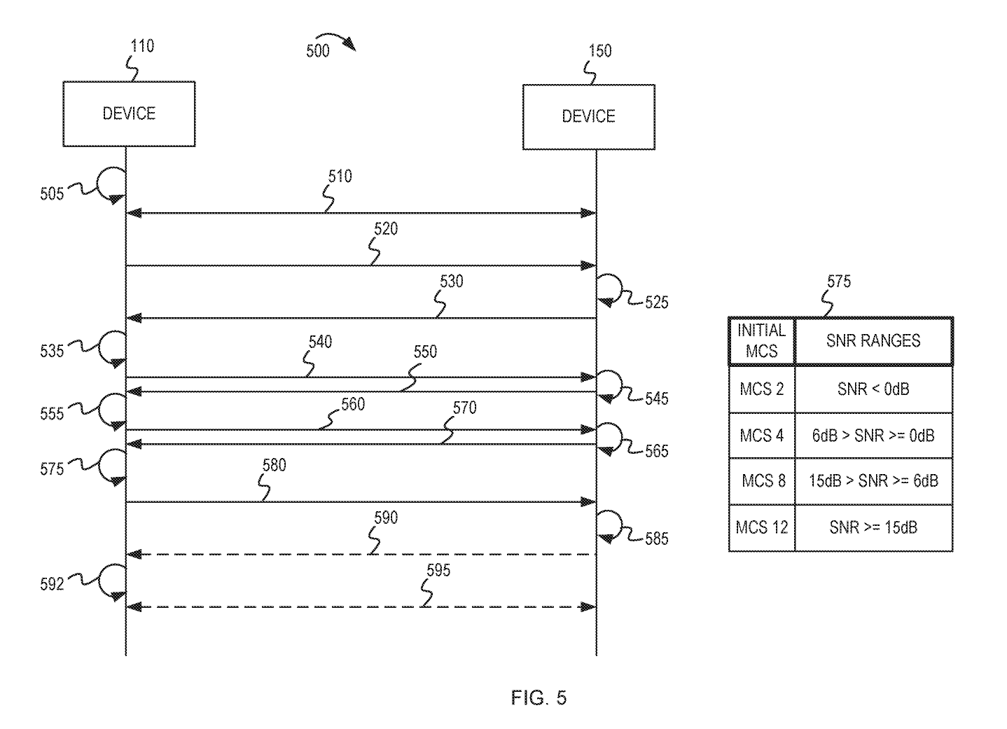

In some implementations, the beamforming-based rate search unit 130 of the device 110 may determine an initial or starting MCS based on the signal strength measurement obtained from the beamforming process, and then determine the MCS based on the results of transmitting probing messages starting with the initial MCS. The device 110 may determine which of a plurality of signal strength ranges includes the signal strength measurement that was derived from the beamforming process. Each of the different signal strength ranges may be associated with a particular MCS. The device 110 may identify the relevant signal strength range based on the signal strength measurement, and then determine the MCS that is associated with the signal strength range. The MCS that is associated with the relevant signal strength is designated as the initial or starting MCS. For example, the device 110 may determine that the signal strength measurement (e.g., SNR of 8 dB) is within a first signal strength range (e.g., 15 dB>SNR>=6 dB). The first signal strength range may be associated with a particular MCS, which may be referred to as the first MCS, such as MCS 8. In this example, the device 110 may select the first MCS as the initial MCS. The device 110 may transmit probing messages using the initial MCS to the device 150 to test the initial MCS and determine whether to select or change the initial MCS. The device 150 may determine whether the probing message that is transmitted using the initial MCS exceeds a packet error rate (PER) threshold. The device 110 can then test either the preceding or the subsequent MCS depending whether the initial or starting MCS exceeds the PER threshold. Then, the device 110 may select the initial MCS, a preceding MCS, or a subsequent MCS depending on one or more feedback messages received from the device 150, as will be further described in FIGS. 5-7. It is noted that since the signal strength measurement focuses the rate search process on an initial MCS that has a high likelihood of being selected as the MCS for the transmissions, the device 110 will typically only send a few probing messages to determine which MCS to use for transmissions from the device 110 to the device 150.

Furthermore, in some implementations, the device 150 may also concurrently perform a similar beamforming and rate search process for determining the MCS to use for transmissions from the device 150 to the device 110, as will be described below in FIG. 2.

FIG. 2 depicts a diagram 200 of example messages that may be transmitted by the WLAN devices during the beamforming process. As described above, the device 110 can transmit an SLS message via each of the transmission sectors 191-199 during the SLS of the beamforming process. As shown in FIG. 2, the device 110 can transit SLS messages 291-299 via the corresponding transmission sectors 191-199 to the device 150. The device 150 may receive the SLS messages 291-299 via the corresponding transmission sectors 191-199. Each of the SLS messages 291-299 may include a sector identifier (ID) (which may also be referred to as transmission sector ID) that identifies a particular transmission sector associated with the SLS message. Thus, based on the sector ID, the device 150 can determine the transmission sector that is associated with each of the received SLS messages 291-299.

The device 150 may perform measurements on each of the received SLS messages 291-299 to determine which of the transmission sectors 191-199 transmitted the strongest signal. For example, the device 150 may compare the signal strength (e.g., SNR or RSSI) measured in each of the transmission sectors 191-199 to determine which transmission sector transmitted the SLS message with the highest signal strength. The device 150 may select the transmission sector that is associated with the strongest signal received by the device 150 (e.g., the signal with the highest signal strength) and determine the signal strength measurement associated with the selected transmission sector. As described above, the selected transmission sector may be associated with the direction that is closest to the location of the device 150 with respect to the device 110. The device 150 may store the sector ID associated with the selected transmission sector and also the signal strength measurement associated with the selected transmission sector, which may be referred to as the results of the beamforming process. The device 150 may then transmit one or more SLS messages to the device 110 that indicate the sector ID and the signal strength measurement associated with the selected transmission sector. In some implementations, the SLS feedback information (e.g., the sector ID and the signal strength measurement) may be included in one or more of the SLS messages that are transmitted from the device 150 to the device 110 in order to perform the beamforming process for the device 150, as will be described below.

In some implementations, as shown in FIG. 2, the device 150 may transmit SLS messages 281-289 via various transmission sectors (not shown) to the device 110, similarly as described above for device 110. One or more of the SLS messages 281-289 may include the SLS feedback information (e.g., the sector ID and the signal strength measurement) derived by the device 150 during the SLS initiated by the device 110. Thus, the SLS messages 281-289 may both facilitate performing the SLS process for the device 150 and also provide the SLS feedback information for the SLS process initiated by the device 110. In some implementations, the device 150 may transmit a separate, dedicated SLS feedback message that includes the SLS feedback information. The frame 210 shown in FIG. 2 illustrates one example frame structure of each of the SLS messages 281-289. The frame 210 may also be an example frame structure of a dedicated SLS feedback message. The frame 210 may include a frame control field 211, a duration field 212, a receiver address (RA) field 213, a transmitter address (TA) field 214, an SLS feedback field 215, and a frame check sequence (FCS) field 217. The SLS feedback field 215 may include a sector ID 222 and a signal strength measurement 224, which may be referred to as the SLS feedback information. In some implementations, the sector ID 222 may be included in a sector select subfield of the SLS feedback field 215, and the signal strength measurement 224 may be included in a signal strength report subfield of the SLS feedback field 215. After receiving the SLS messages 281-289 (and/or the dedicated SLS feedback message), the device 110 may store the sector ID 222 and the signal strength measurement 224 associated with the selected transmission sector.

In some implementations, the device 110 may perform similar beamforming operations as described above for the device 150. The device 110 may perform measurements on each of the SLS messages 281-289 to determine which of the transmission sectors transmitted the strongest signal. The device 110 may select the transmission sector that transmitted the strongest signal (e.g., the signal with the highest signal strength) and determine the signal strength measurement associated with the selected transmission sector. The device 110 may store the sector ID and the signal strength measurement associated with the selected transmission sector. The device 110 may then transmit an SLS feedback message 245 to the device 150 that indicates the sector ID and the signal strength measurement associated with the selected transmission sector. The SLS feedback message 245 that includes the sector ID and the signal strength measurement may indicate the results of the beamforming process for the device 150. The SLS feedback message 245 may also be referred to as the sector sweep feedback message (SS feedback message or SSW-FB message). The SLS feedback message 245 may have a similar frame structure as shown in frame 210 and described above. The device 150 may store the sector ID and the signal strength measurement that was included in the SLS feedback message 245. The device 150 may also transmit a SLS acknowledgement message 265 to the device 110 indicating it received the SLS feedback message 245. The SLS acknowledgement message may also be referred to as the sector sweep acknowledgement message (SS acknowledgement message or SSW-ACK message).

After the device 110 and the device 150 perform the beamforming process, the device 110 may initiate the optimized rate search process to select one of the available MCSs for transmissions from the device 110 to the device 150. In some implementations, the device 150 may similarly implement the optimized rate search process to select one of the available MCSs for transmissions from the device 150 to the device 110.

FIG. 3 shows an example message flow diagram of the WLAN devices implementing the optimized rate search process. The message flow diagram 300 includes messages between the device 110 and the device 150.

At 305, the device 110 determines to establish a communication link with the device 150 to communicate with the device 150. For example, the device 110 may be a mobile phone and the device 150 may be an access point, or the device 110 may be a tablet computer and the device 150 may be a smart television.

At 310, the device 110 and the device 150 perform a wireless association process to establish a communication link. For example, the device 110 and the device 150 may establish the communication link after exchanging device and network credentials and capabilities (and other related information) in accordance with an association protocol defined in the IEEE 802.11 standards.

At 320, after completing the wireless association process, the device 110 initiates the beamforming process, and transmits SLS messages to the device 150 during the SLS of the beamforming process. As described in FIG. 2, the device 110 transmits SLS messages (e.g., SLS messages 291-299) to the device 150 via various transmission sectors that transmit in different directions with respect to the device 110.

At 325, the device 150 determines which of the transmission sectors transmitted the strongest signal based on measurements performed by the device 150 on the received SLS messages. For example, the device 150 may determine the signal strength associated with each of the received SLS messages, and compare the signal strength measurements to determine and select the transmission sector associated with the strongest signal. The device 150 also determines the sector ID and the signal strength measurement associated with the selected transmission sector.

At 330, the device 150 transmits SLS messages to the device 110. For example, as described in FIG. 2, the device 150 may transmit the SLS messages 281-289 to the device 110. The SLS messages may both facilitate performing the SLS of the beamforming process for the device 150 and also provide the SLS feedback information for the SLS initiated by the device 110. The SLS messages may include the sector ID and the signal strength measurement (e.g., SNR or RSSI) associated with the transmission sector that was selected during the SLS for the device 110. As described in FIG. 2, in some implementations, the device 150 may transmit a dedicated SLS feedback message, or may transmit both a dedicated SLS feedback message and SLS messages that include the SLS feedback information.

At 335, the device 110 receives the SLS messages, and determines the sector ID and the signal strength measurement (e.g., sector ID 222 and signal strength measurement 224) associated with the selected transmission sector. The device 110 may directly determine the MCS for use in transmissions from the device 110 to the device 150 based on the signal strength measurement and, unlike traditional rate search processes, without the delays associated with sending probing messages during the rate search process. The device 110 may access an MCS table to determine the MCS that is associated with the signal strength measurement. For example, the device 110 can access the MCS table in Table 1.

TABLE 1
MCS table

| MCS INDEX | RATE (Mbps) | SNR (dB) |
|---|---|---|
| MCS 0 | 27.5 | −12 |
| MCS 1 | 385 | 0.35 |
| MCS 2 | 770 | 0.71 |
| MCS 3 | 962.5 | 2 |
| MCS 4 | 1155 | 3.3 |
| MCS 5 | 1251 | 4 |
| MCS 6 | 1540 | 3.64 |
| MCS 7 | 1920 | 4.9 |
| MCS 8 | 2310 | 6.35 |
| MCS 9 | 2502 | 7 |
| MCS 10 | 3080 | 11.1 |
| MCS 11 | 3850 | 12 |

The MCS table is one example MCS table that lists the MCS index with the associated data rate and SNR. The example MCS table shown in Table 1 lists only the data rate and SNR for simplicity; however, it is noted that other example MCS tables may list additional parameters. In some implementations, the designer, developer, and/or the manufacturer of the communication module (which implements the protocols defined in the IEEE 802.11 standards) of the device 110 may derive and test the SNR values of the MCS table and store the MCS table in the communication module for use during the rate search process. For example, for a given MCS, it is determined what SNR value results in a less than predefined PER (e.g., less than 10% PER). An SNR value may be determined for each of the available MCSs and these SNR values may be included in the MCS table. Furthermore, it is noted that other example MCS tables may list RSSI values instead of SNR values.

In one example, the device 110 may determine that the signal strength measurement derived during the SLS of the beamforming process is an SNR of 11 dB. Based on the MCS table, the device 110 may determine that the MCS 10 is associated with an SNR of 11.1 dB. Thus, the device 110 may select the MCS 10 to use for transmissions from the device 110 to the device 150. In some implementations, the device 110 may select the MCS index that is associated with a signal strength that is closest to the signal strength measurement derived during the beamforming process. If the signal strength measurement falls equally between two MCS index values, the device 110 may round up to the higher MCS. In some implementations, the device 110 may round up to the higher MCS when the signal strength measurement falls anywhere in between two MCS index values. For example, if the signal strength measurement is an SNR of 7.5 dB, the device 110 may still select the MCS 10 after rounding up to the higher MCS index value (when the signal strength measurement falls in between two MCS index values).

Furthermore, at 335, when the device 110 receives the SLS messages (e.g., SLS messages 281-289) from the device 150, the device 110 may also perform measurements on each of the SLS messages to select a transmission sector and perform the beamforming process for the device 150, as described in FIG. 2.

At 340, the device 110 sends one or more transmissions to the device 150 using the MCS that was selected based on the signal strength measurement derived during the beamforming process. For example, if the device 110 is a tablet computer and the device 150 is a smart television, the device 110 may send video or other media for display on the smart television. Also, as described above, the device 110 may focus a greater percentage of the energy or power of the transmissions in the transmission sector that was selected during the SLS of the beamforming process. Furthermore, as described in FIG. 2, the device 110 may also transmit an SLS feedback message (e.g., SLS feedback message 245) to the device 150 that indicates the sector ID and the signal strength measurement associated with the transmission sector that was selected during the beamforming process for device 150.

At 345, the device 150 processes the transmissions received from the device 110. For example, the device 150 may process the video or other media received from device 110. Furthermore, the device 150 may process the SLS feedback message (e.g., SLS feedback message 245) received from the device 110 to perform its own rate search process. Similar to the techniques described herein for the device 110, the device 150 may select an MCS based on the signal strength measurement that is included in the SLS feedback message. The device 150 may also send transmissions to the device 110 using the MCS that is selected during its rate search process.

At 350, the device 150 may send one or more acknowledgement messages (ACKs) to acknowledge receipt of the transmissions sent (at 340) by the device 110. As shown by the dashed lines, the device 150 may not send an ACK message if the device detected an error in the transmissions, if the device did not receive the transmissions, or if the device rejected the transmissions.

At 355, the device 110 may determine whether it received one or more ACK messages from the device 150. If the device 110 received an ACK message from the device 150 for a transmission, the device 110 may determine that the transmission was successful. If the device 110 determines that it did not receive an ACK message for one or more of the transmissions, then it may determine whether a packet error rate (PER) threshold associated with the transmissions meet the PER threshold. When the device 110 determines that the PER threshold associated with the transmissions is not met, this may indicate one or both devices have been moved or the channel conditions have changed. The determination that the PER threshold is not met may trigger the device 110 to initiate new beamforming and rate search processes. The messages shown in 360 below are optional (as shown by the dashed line), depending whether or not the device 110 determines to initiate new beamforming and rate search processes.

At 360, the devices 110 and 150 may exchange messages and other communications (similarly as described above) to perform new beamforming and rate search processes.

FIG. 4 shows an example flowchart of a WLAN device implementing the optimized rate search process. The flowchart 400 begins at block 410.

At block 410, the first device may receive a result of a beamforming process from a second device. The result of the beamforming process may include a signal strength measurement. The result of the beamforming process may also include a selected transmission sector. In some implementations, the first device may receive one or more SLS messages (e.g., the SLS messages 281-289) from the second device that indicate the result of the beamforming process. For example, the SLS messages may include an indication of the selected transmission sector and the signal strength measurement associated with the selected transmission sector. The first device may determine the signal strength measurement based on the received SLS messages. The signal strength measurement is associated with the first transmission sector that was selected based on the SLS of the beamforming process, as described above in FIGS. 1 and 2.

At block 420, the first device may determine an MCS for transmissions from the first device to the second device based, at least in part, on the signal strength measurement determined from the beamforming process. The first device may perform the optimized rate search process after receiving one or more SLS messages (e.g., the SLS messages 281-289) from the second device indicating the result of the beamforming process. The one or more SLS messages may indicate the result of the beamforming process by including the sector ID associated with the selected transmission sector and the signal strength measurement associated with the selected transmission sector. The first device may determine the MCS that is associated with the signal strength measurement based on an MCS table, as described above in FIG. 3. The first device may determine the MCS based on the MCS table and without using probing messages during the rate search process. In some implementations, the first device may determine an initial or starting MCS based on the signal strength measurement, and may test the initial or starting MCS using probing messages to determine whether to select or change the initial MCS, as will be further described in FIGS. 5-7.

FIG. 5 shows an example message flow diagram of WLAN devices implementing the optimized rate search process that determines an initial or starting MCS. The message flow diagram 500 includes messages between the device 110 and the device 150.

At 505, the device 110 determines to establish a communication link with the device 150 to communicate with the device 150.

At 510, the device 110 and the device 150 perform a wireless association process to establish a communication link. For example, the device 110 and the device 150 may establish the communication link after exchanging device and network credentials and capabilities and other information in accordance with an association protocol defined in the IEEE 802.11 standards.

At 520, after completing the wireless association process, the device 110 initiates the beamforming process. As described in FIG. 2, during the SLS of the beamforming process, the device 110 transmits SLS messages to the device 150 via various transmission sectors that transmit in different directions with respect to the device 110.

At 525, the device 150 determines which of the transmission sectors transmitted the strongest signal based on measurements performed on the received SLS messages by the device 150. For example, the device 150 may determine the signal strength associated with each of the received SLS messages, and compare the signal strength measurements to determine and select the transmission sector associated with the strongest signal. The device 150 also determines the sector ID and the signal strength measurement associated with the selected transmission sector.

At 530, the device 150 transmits SLS messages to the device 110. For example, as described in FIG. 2, the device 150 may transmit the SLS messages 281-289 to the device 110. The SLS messages may both facilitate performing the SLS of the beamforming process for the device 150 and also provide the SLS feedback information for the SLS initiated by the device 110. The SLS messages may include the sector ID and the signal strength measurement (e.g., SNR or RSSI) associated with the transmission sector that was selected during the SLS for the device 110. As described in FIG. 2, in some implementations, the device 150 may transmit a dedicated SLS feedback message, or may transmit both a dedicated SLS feedback message and SLS messages that include the SLS feedback information.

At 535, the device 110 receives the SLS messages, and determines the sector ID and the signal strength measurement (e.g., SNR or RSSI) associated with the selected transmission sector. In some implementations, the device 110 may determine an initial MCS based on the signal strength measurement. The device 110 may access an initial MCS table having a plurality of signal strength ranges, where each range is associated with an initial MCS. The device 110 may determine the initial MCS based on the signal strength measurement and the plurality of signal strength ranges. For example, the initial MCS table 575 shown in FIG. 5 includes four SNR ranges and four initial MCSs. Each of the SNR ranges is associated with one of the initial MCSs. The device 110 may determine which SNR range is associated with the signal strength measurement (e.g., an SNR measurement). In other words, the device 110 may identify which SNR range includes the SNR measurement. For example, the device 110 may determine that the SNR measurement is 8dB, and that the SNR measurement is within the third SNR range (e.g., 15 dB 22 SNR>=6 dB) shown in the initial MCS table 575. The device 110 may also determine that the initial MCS associated with this particular SNR range is the MCS 8. Thus, in this example, the device 110 may select the MCS 8 as the initial MCS.

As shown in the initial MCS table 575, in some implementations, the MCS 2 is selected as the initial MCS when the SNR measurement is less than 0 dB, the MCS 4 is selected when the SNR measurement is greater than or equal to 0 dB and less than 6 dB, the MCS 8 is selected when the SNR measurement is greater than or equal to 6 dB and less than 15 dB, and the MCS 12 is selected when the SNR measurement is greater than or equal to 15 dB. In some implementations, the designer, developer, and/or the manufacturer of the communication module (which implements the protocols defined in the IEEE 802.11 standards) of the device 110 may derive and test the initial MCS values and signal strength ranges of the initial MCS table 575 and store the initial MCS table 575 in the communication module for use during the rate search process. Furthermore, it is noted that other example initial MCS tables may list RSSI values instead of SNR values.

Also, when the device 110 receives the SLS messages (e.g., SLS messages 281-289) from the device 150, the device 110 may perform measurements on each of the SLS messages to select a transmission sector and perform the beamforming process for the device 150, as described in FIG. 2.

At 540, the device 110 transmits one or more probing messages using the initial MCS to the device 150 to test whether transmissions using the initial MCS meet a PER threshold. In some implementations, the probing messages that are transmitted during the rate search process may be one or more data packets. The PER threshold may be preconfigured and also configurable. In one example, the PER threshold may be 10%; however, the PER may be configurable to a different percentage or value.

Furthermore, as described in FIG. 2, the device 110 may also transmit an SLS feedback message (e.g., SLS feedback message 245) to the device 150 that indicates the sector ID and the signal strength measurement associated with the transmission sector that was selected during the beamforming process for device 150.

At 545, the device 150 receives the one or more probing messages that were transmitted by the device 110 using the initial MCS, and determines whether the PER associated with the probing messages meet the PER threshold.

At 550, the device 150 then provides a feedback message to the device 110 indicating whether or not the initial MCS meets the PER threshold. In some implementations, the feedback message may be an ACK message that indicates whether or not the initial MCS meets the PER threshold.

At 555, the device 110 receives the feedback message from the device 150 and determines whether or not the initial MCS met the PER threshold based on the received feedback message. If the initial MCS met the PER threshold, then the device 110 selects a next higher MCS in an MCS index after the initial MCS (which may also be referred to as the subsequent MCS). In the example described above, since the initial MCS was the MCS 8, the device 110 selects the next higher MCS, which is MCS 9. If the initial MCS did not meet the PER threshold, then the device 110 selects a next lower MCS in an MCS index before the initial MCS (which may also be referred to as the preceding MCS). In the example described above, since the initial MCS was the MCS 8, the device 110 selects the next lower MCS, which is MCS 7.

At 560, the device 110 transmits one or more probing messages to test whether the next selected MCS meets the PER threshold. If the initial MCS met the PER threshold, then the device 110 transmits one or more probing messages using the next higher MCS after the initial MCS. If the initial MCS did not meet the PER threshold, then the device 110 transmits one or more probing messages using the next lower MCS before the initial MCS.

At 565, the device 150 receives the one or more probing messages that were transmitted by the device 110 using either the next higher MCS or the next lower MCS, and determines whether the PER associated with the probing messages meet the PER threshold.

At 570, the device 150 provides a feedback message to the device 110 indicating whether or not the next higher MCS or the next lower MCS met the PER threshold.

At 575, the device 110 receives the feedback message from the device 150 and determines whether or not the next higher MCS or the next lower MCS met the PER threshold based on the received feedback message. If the device 110 transmitted probing messages using the next higher MCS after the initial MCS, and the next higher MCS did not meet the PER threshold, then the device 110 selects the initial MCS for the transmissions from the device 110 to the device 150. If the next higher MCS meets the PER threshold, then the device 110 may select a subsequent MCS and transmit one or more probing messages to test the subsequent MCS in the same manner as described herein. The device 110 may select the next higher MCS for the transmissions from the device 110 to the device 150 if the subsequent MCS does not meet the PER threshold.

If the device 110 transmitted probing messages using the next lower MCS before the initial MCS, and the next lower MCS meets the PER threshold, then the device 110 selects the next lower MCS for the transmissions from the device 110 to the device 150. If the next lower MCS does not meet the PER threshold, then the device 110 may select a preceding MCS and transmit one or more probing messages to test the preceding MCS in the same manner as described herein. The device 110 may select the preceding MCS for the transmissions from the device 110 to the device 150 if the preceding MCS meets the PER threshold.

Furthermore, the device 150 may also determine an initial MCS based on the signal strength measurement received from the device 110, and perform the rate search process similarly as described for device 110 in order to select an MCS for transmissions from the device 150 to the device 110.

At 580, the device 110 sends one or more transmissions to the device 150 using the selected MCS described above. Also, the device 110 may focus a greater percentage of the energy or power of the transmissions in the transmission sector that was selected during the SLS of the beamforming process.

At 585, the device 150 processes the transmissions received from the device 110. The device 150 may also send transmissions to the device 110 using the MCS selected during the rate search process for the device 150.

At 590, the device 150 may send one or more acknowledgement messages (ACKs) to acknowledge receipt of the transmissions sent (at 580) by the device 110. As shown by the dashed lines, the device 150 may not send an ACK message if the device detected an error in the transmissions, if the device did not receive the transmissions, or if the device rejected the transmissions.

At 592, the device 110 may determine whether it received one or more ACK messages from the device 150. If the device 110 received an ACK message from the device 150 for a transmission, the device 110 may determine that the transmission was successful. If the device 110 determines that it did not receive an ACK message for one or more of the transmissions, then it may determine whether a packet error rate (PER) threshold associated with the transmissions meet the PER threshold. When the device 110 determines that the PER threshold associated with the transmissions is not met, this may indicate one or both devices have been moved or the channel conditions have changed. The determination that the PER threshold is not met may trigger the device 110 to initiate new beamforming and rate search processes. The messages shown in 595 below are optional (as shown by the dashed line), depending on whether the device 110 determines to initiate new beamforming and rate search processes.

At 595, the devices 110 and 150 may exchange messages and other communications (similarly as described above) to perform new beamforming and rate search processes.

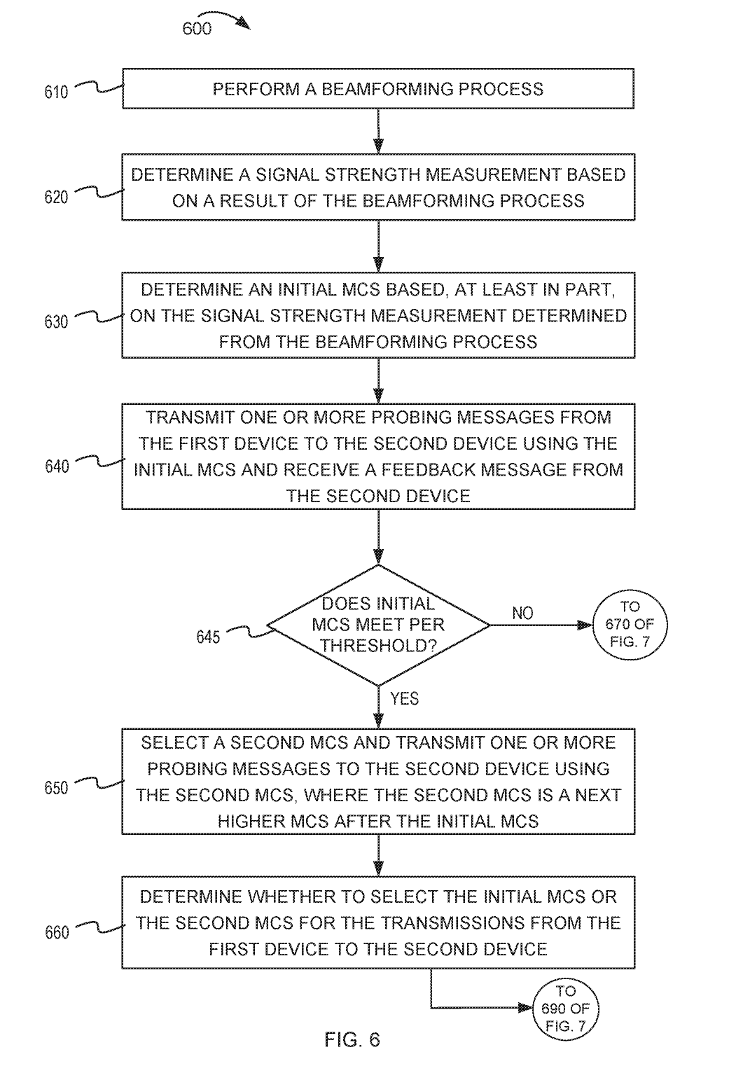

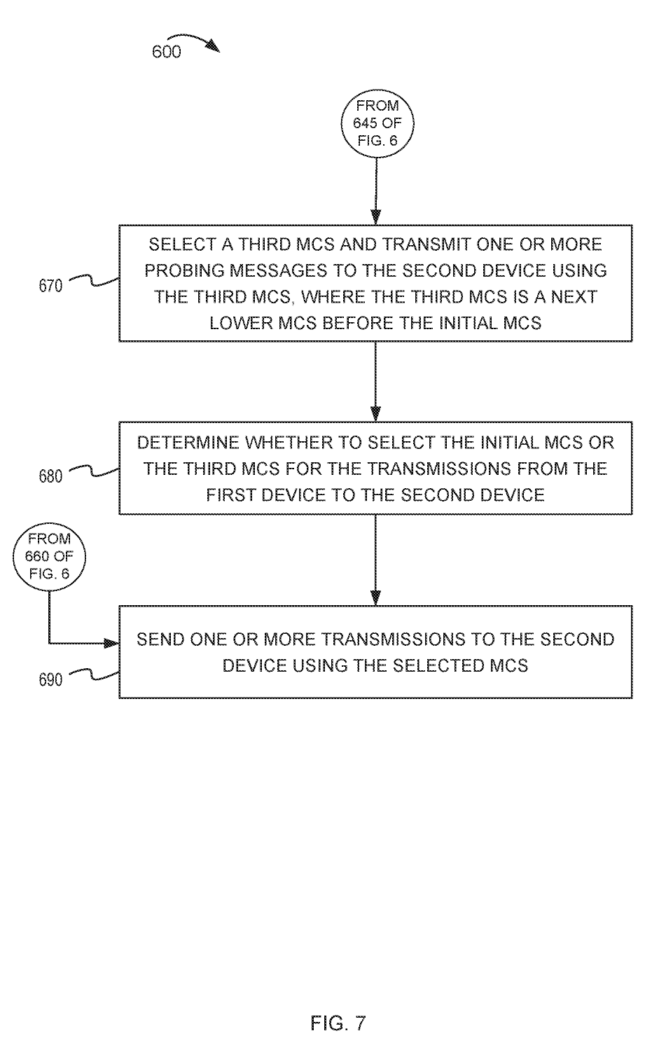

FIG. 6 and FIG. 7 show an example flowchart of a WLAN device implementing the optimized rate search process that determines an initial or starting MCS. The flowchart 600 begins at block 610.

At block 610, the first device may perform a beamforming process. The first device may perform a SLS during the beamforming process to select a first transmission sector of a plurality of transmission sectors, as described above in FIGS. 1 and 2.

At block 620, the first device may determine a signal strength measurement based on a result of the beamforming process. The first device may determine the signal strength measurement associated with the first transmission sector selected based on the SLS of the beamforming process, as described above in FIGS. 1 and 2. For example, the first device may determine the signal strength measurement based on SLS messages received from the second device that includes the transmission sector selected by the second device, and the signal strength measurement associated with the selected transmission sector that was measured by the second device.

At block 630, the first device may determine an initial MCS based, at least in part, on the signal strength measurement determined from the beamforming process. The first device may access an initial MCS table having a plurality of signal strength ranges, where each range is associated with an initial MCS. The first device may determine the initial MCS based on the signal strength measurement and the plurality of signal strength ranges. For example, the first device may identify which signal strength range includes the signal strength measurement, and select the initial MCS associated with the signal strength range.

At block 640, the first device may transit one or more probing messages to the second device using the initial MCS. The first device may also receive a feedback message from the second device.

At block 645, the first device may determine whether the one or more probing messages that were transmitted using the initial MCS met the PER threshold. For example, the feedback message received from the second device may indicate whether the one or more probing messages met the PER threshold, and the first device may process the received feedback message to determine whether the PER threshold was met. If it is determined that the one or more probing messages met the PER threshold, the flow continues at block 650. Otherwise, the flow continues at block 670 of FIG. 7.

At block 650, the first device may select a second MCS and transmit one or more probing messages to the second device using the second MCS, where the second MCS is a next higher MCS after the initial MCS. For example, if the first device selects MCS 8 as the initial MCS, the next higher MCS in the MCS index is MCS 9.

At block 660, the first device may determine whether to select the initial MCS or the second MCS for the transmissions from the first device to the second device. The first device may receive a feedback message that indicates whether the one or more probing messages that were transmitted using the next higher MCS met the PER threshold. If the one or more probing messages did not meet the PER threshold, then the first device may select the initial MCS for the transmissions from the first device to the second device. If the one or more probing messages met the PER threshold, then the first device may select either the next higher MCS or a subsequent MCS based on further PER-based analysis after exchanging one or more additional probing messages and one or more additional feedback messages. After block 660, the flow continues at block 690 of FIG. 7.

At block 670 of FIG. 7, if it is determined that the one or more probing messages that were transmitted using the initial MCS did not meet the PER threshold (after block 645 of FIG. 6), the first device may select a third MCS and transmit one or more probing messages to the second device using the third MCS, where the third MCS is a next lower MCS before the initial MCS. For example, if the first device selects MCS 8 as the initial MCS, the next lower MCS in the MCS index is MCS 7.

At block 680, the first device may determine whether to select the initial MCS or the third MCS for the transmissions from the first device to the second device. The first device may receive a feedback message that indicates whether the one or more probing messages that were transmitted using the next lower MCS met the PER threshold. If the one or more probing messages met the PER threshold, then the first device may select the next lower MCS for the transmissions from the first device to the second device. If the one or more probing messages did not meet the PER threshold, then the first device may transmit one or more additional probing message to test the preceding MCS before the next lower MCS, and then determine which MCS to select for the transmissions from the first device to the second device based on one or more additional feedback messages.

At block 690, after either block 660 of FIG. 6 or after block 680 of FIG. 7, the first device may send one or more transmissions to the second device using the selected MCS. For example, if the selected MCS is the initial MCS, the first device may send one or more transmissions to the second device using the MCS 8.

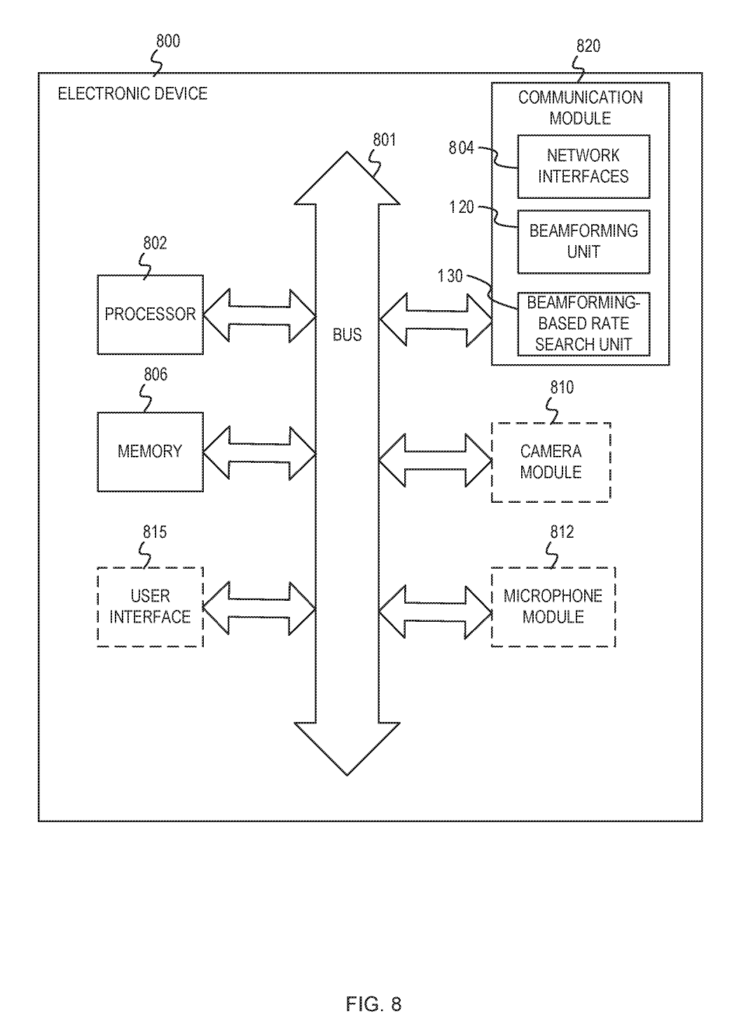

FIG. 8 shows a block diagram of an example electronic device 800 for implementing aspects of this disclosure. In some implementations, the electronic device 800 may be representative of either device 110 or the device 150. The electronic device 800 may be a laptop computer, a tablet computer, a mobile phone, a gaming console, a smartwatch, a wearable device, an access point, a network router, a range extender, a smart appliance, or another electronic system. The electronic device 800 includes a processor 802 (possibly including multiple processors, multiple cores, multiple nodes, or implementing multi-threading, etc.). The electronic device 800 includes a memory 806. The memory 806 may be system memory or any one or more of the below-described possible realizations of a machine-readable medium or computer-readable medium. The electronic device 800 also may include a bus 801 (such as PCI, ISA, PCI-Express, HyperTransport®, InfiniBand®, NuBus, AHB, AXI, etc.). The electronic device 800 may include one or more network interfaces 804, that can include at least one of a wireless network interface (such as a WLAN interface, a Bluetooth® interface, a WiMAX® interface, a ZigBee® interface, a Wireless USB interface, etc.) and a wired network interface (such as an Ethernet interface, a powerline communication interface, etc.). In some implementations, the electronic device 800 may support one or more network interfaces 804, each of which may be configured to couple the electronic device 800 to a different communication network.

The electronic device 800 may include a communication module 820. In some implementations, the communication module 820 may include the one or more network interfaces 804. As described in FIG. 1, the one or more network interfaces 804 may be representative of the one or more modems, one or more antennas, analog front end (AFE), and other communication-related components of the electronic device 800. The communication module 820 may include the beamforming unit 120 and the beamforming-based rate search unit 130. The beamforming unit 120 may implement the beamforming process, as described in FIGS. 1-7. The beamforming-based rate search unit 130 may implement one of the rate search techniques described in FIG. 1-7.

The memory 806 includes functionality to support various implementations. The memory 806 can include computer instructions executable by the processor 802 to implement the functionality of the implementations described in FIGS. 1-7. For example, the memory 806 may include one or more functionalities that facilitate implementation of the optimized rate search processes described in FIGS. 1-7. In some implementations, the communication module 820 may perform some or all of the operations described herein. For example, the communication module 820 may include an additional processor (such as a baseband processor) and additional memory that may include computer instructions executable by the additional processor to implement some or all of the functionality of the implementations described in FIGS. 1-7. In some implementations, the additional processor(s) and memory of the communication module 820, the processor 802 and the memory 806, or a combination of some or all of these components can implement the beamforming units and the beamforming-based rate search units described in FIG. 1. In some implementations, the electronic device 800 also may include additional components, such as a camera module 810, a microphone module 812, a user interface 815, and other input/output components. For example, if the electronic device 800 is a STA or is a device that is operating as an AP (such as a software enabled AP or “SoftAP”), the STA may include the camera module 810, the microphone module 812, and the user interface 815. A dedicated or stand-alone AP may include some version of the user interface 815, but may not include the camera module 810 or the microphone module 812.

Any one of these functionalities may be partially (or entirely) implemented in hardware or on the processor 802. For example, the functionality may be implemented with an application specific integrated circuit, in logic implemented in the processor 802, in a co-processor on a peripheral device or card, etc. Further, realizations may include fewer or additional components not illustrated in FIG. 8 (such as video cards, audio cards, additional network interfaces, peripheral devices, etc.). The processor 802, the memory 806, and the communication module 820 may be coupled to the bus 801. Although illustrated as being coupled to the bus 801, the memory 806 may be directly coupled to the processor 802. Furthermore, although illustrated as being within to the communication module 820, in some implementations the network interfaces 804 may be a separate module that is directly coupled to the bus 801.

It is noted that the description is directed to certain implementations for the purposes of describing the innovative aspects of this disclosure. However, a person having ordinary skill in the art will readily recognize that the teachings herein can be applied in a multitude of different ways. The examples in this disclosure are based on wireless local area network (WLAN) communication according to the Institute of Electrical and Electronics Engineers (IEEE) 802.11 wireless standards. However, the described implementations may be implemented in any device, system or network that is capable of transmitting and receiving radio frequency (RF) signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or interne of things (IoT) network, such as a system utilizing 3G, 4G or 5G, or further implementations thereof, technology.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described throughout. Whether such functionality is implemented in hardware or software depends on the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include cache memory, RAM (including SRAM, DRAM, zero capacitor RAM, Twin Transistor RAM, eDRAM, EDO RAM, DDR RAM, EEPROM, NRAM, RRAM, SONOS, PRAM, or the like), ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray™ disc where disks usually reproduce data magnetically, while discs reproduce data optically with lasers. Combinations also can be included within the scope of computer-readable media. Additionally, the operations of a method or algorithm may reside as one or any combination or set of codes and instructions on a machine-readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method for performing a rate search process, comprising:
receiving, by a first device, a result of a beamforming process from a second device, the result of the beamforming process including a signal strength measurement; and
determining, by the first device, a modulation and coding scheme (MCS) for transmissions from the first device to the second device based, at least in part, on the signal strength measurement determined from the beamforming process.

2. The method of claim 1, wherein receiving the result of the beamforming process from the second device comprises:
performing a sector level sweep of the beamforming process;
receiving a result of the sector level sweep of the beamforming process from the second device, the result of the sector level sweep including the signal strength measurement and a transmission sector identifier;
selecting a first transmission sector from a plurality of transmission sectors based on the transmission sector identifier; and
determining the signal strength measurement associated with the first transmission sector based on the result of the sector level sweep of the beamforming process.

3. The method of claim 1, wherein determining the MCS for transmissions from the first device to the second device, comprises:
determining the MCS that is associated with the signal strength measurement based on an MCS table; and
selecting the MCS that is associated with the signal strength measurement for transmissions from the first device to the second device.

4. The method of claim 1, wherein determining the MCS for transmissions from the first device to the second device, comprises:
performing the rate search process after receiving the result of the beamforming process from the second device, the result of the beamforming process including the signal strength measurement;
determining the MCS based, at least in part, on the signal strength measurement determined from the beamforming process and without using probing messages during the rate search process; and
selecting the MCS that is associated with the signal strength measurement for transmissions from the first device to the second device.

5. The method of claim 1, wherein determining the MCS for transmissions from the first device to the second device, comprises:
determining the signal strength measurement is within a first signal strength range of a plurality of signal strength ranges, the first signal strength range associated with a first MCS;
selecting the first MCS associated with the first range as an initial MCS;
transmitting a first probing message to the second device using the initial MCS; and
determining whether to select or change the initial MCS based on one or more feedback messages received from the second device.

6. The method of claim 5, wherein determining whether to select or change the initial MCS based on one or more feedback messages received from the second device, comprises:
receiving a first feedback message from the second device indicating whether the first probe message transmitted using the initial MCS met a packet error rate (PER) threshold;
in response to determining the first probe message transmitted using the initial MCS met the PER threshold,
selecting a second MCS and transmitting a second probing message to the second device using the second MCS, wherein the second MCS is a next higher MCS in an MCS index after the initial MCS;
receiving a second feedback message from the second device indicating whether the second probe message transmitted using the second MCS met the PER threshold;
in response to determining the second probe message did not meet the PER threshold, selecting the initial MCS for transmissions from the first device to the second device; and
in response to determining the second probe message met the PER threshold, determining whether to select the second MCS based on at least one additional feedback message that is received from the second device.

7. The method of claim 5, wherein determining whether to select or change the initial MCS based on one or more feedback messages received from the second device, comprises:
receiving a first feedback message from the second device indicating whether the first probe message transmitted using the initial MCS met a packet error rate (PER) threshold;
in response to determining the first probe message transmitted using the initial MCS did not meet the PER threshold,
selecting a second MCS and transmitting a second probing message to the second device using the second MCS, wherein the second MCS is a next lower MCS in an MCS index before the initial MCS;
receiving a second feedback message from the second device indicating whether the second probe message transmitted using the second MCS met the PER threshold;
in response to determining the second probe message met the PER threshold, selecting the second MCS for transmissions from the first device to the second device; and
in response to determining the second probe message did not meet the PER threshold, determining whether to select a third MCS based on at least one additional feedback message received from the second device, wherein the third MCS is a next lower MCS in an MCS index before the second MCS.

8. The method of claim 1, wherein the signal strength measurement is a signal-to-noise ratio (SNR) or a received signal strength indicator (RSSI).

9. The method of claim 1, wherein the first and second devices are wireless local area network (WLAN) devices.

10. A first device, comprising:
a processor; and
memory having instructions stored therein which, when executed by the processor cause the first device to:
receive a result of a beamforming process from a second device, the result of the beamforming process including a signal strength measurement; and
determine a modulation and coding scheme (MCS) for transmissions from the first device to the second device based, at least in part, on the signal strength measurement determined from the beamforming process.

11. The first device of claim 10, wherein the instructions, when executed by the processor, further cause the first device to:
perform a sector level sweep of the beamforming process;
receiving a result of the sector level sweep of the beamforming process from the second device, the result of the sector level sweep including the signal strength measurement and a transmission sector identifier;
select a first transmission sector from a plurality of transmission sectors based on the transmission sector identifier; and
determine the signal strength measurement associated with the first transmission sector based on the result of the sector level sweep of the beamforming process.

12. The first device of claim 10, wherein the instructions, when executed by the processor, further cause the first device to:
determine the MCS that is associated with the signal strength measurement based on an MCS table; and
select the MCS that is associated with the signal strength measurement for transmissions from the first device to the second device.

13. The first device of claim 10, wherein the instructions, when executed by the processor, further cause the first device to:
perform a rate search process after receiving the result of the beamforming process from the second device, the result of the beamforming process including the signal strength measurement;
determine the MCS based, at least in part, on the signal strength measurement determined from the beamforming process and without using probing messages during the rate search process; and
select the MCS that is associated with the signal strength measurement for transmissions from the first device to the second device.

14. The first device of claim 10, wherein the instructions, when executed by the processor, further cause the first device to:
determine the signal strength measurement is within a first signal strength range of a plurality of signal strength ranges, the first signal strength range associated with a first MCS;
select the first MCS associated with the first range as an initial MCS;
transmit a first probing message to the second device using the initial MCS; and
determine whether to select or change the initial MCS based on one or more feedback messages received from the second device.

15. The first device of claim 14, wherein the instructions, when executed by the processor, further cause the first device to:
receiving a first feedback message from the second device indicating whether the first probe message transmitted using the initial MCS met a packet error rate (PER) threshold;
in response to determining the first probe message transmitted using the initial MCS met the PER threshold,
selecting a second MCS and transmitting a second probing message to the second device using the second MCS, wherein the second MCS is a next higher MCS in an MCS index after the initial MCS;
receiving a second feedback message from the second device indicating whether the second probe message transmitted using the second MCS met the PER threshold;
in response to determining the second probe message did not meet the PER threshold, selecting the initial MCS for transmissions from the first device to the second device; and
in response to determining the second probe message met the PER threshold, determining whether to select the second MCS based on at least one additional feedback message that is received from the second device.

16. The first device of claim 14, wherein the instructions, when executed by the processor, further cause the first device to:
receiving a first feedback message from the second device indicating whether the first probe message transmitted using the initial MCS met a packet error rate (PER) threshold;
in response to determining the first probe message transmitted using the initial MCS did not meet the PER threshold,
selecting a second MCS and transmitting a second probing message to the second device using the second MCS, wherein the second MCS is a next lower MCS in an MCS index before the initial MCS;
receiving a second feedback message from the second device indicating whether the second probe message transmitted using the second MCS met the PER threshold;
in response to determining the second probe message met the PER threshold, selecting the second MCS for transmissions from the first device to the second device; and
in response to determining the second probe message did not meet the PER threshold, determining whether to select a third MCS based on at least one additional feedback message that is received from the second device, wherein the third MCS is the next lower MCS in the MCS index before the second MCS.

17. A first device, comprising:
means for performing a sector level sweep of a beamforming process;
means for receiving a result of the sector level sweep of the beamforming process from a second device, the result of the sector level sweep including an indication of a first transmission sector and a signal strength measurement;
means for selecting the first transmission sector from a plurality of transmission sectors based on the result of the sector level sweep of the beamforming process;
means for determining the signal strength measurement associated with the first transmission sector based on the result of the sector level sweep of the beamforming process; and
means for determining a modulation and coding scheme (MCS) for transmissions from the first device to the second device based, at least in part, on the signal strength measurement determined from the sector level sweep of the beamforming process.

18. The first device of claim 17, further comprising:
means for determining the MCS that is associated with the signal strength measurement based on an MCS table; and
means for selecting the MCS that is associated with the signal strength measurement for transmissions from the first device to the second device.

19. The first device of claim 17, further comprising:
means for performing a rate search process after performing the beamforming process;
means for determining the MCS based, at least in part, on the signal strength measurement determined from the sector level sweep of the beamforming process and without using probing messages during the rate search process; and
means for selecting the MCS that is associated with the signal strength measurement for transmissions from the first device to the second device.

20. The first device of claim 17, further comprising:
means for determining the signal strength measurement is within a first signal strength range of a plurality of signal strength ranges, the first signal strength range associated with a first MCS;
means for selecting the first MCS associated with the first range as an initial MCS;
means for transmitting a first probing message to the second device using the initial MCS; and
means for determining whether to select or change the initial MCS based on one or more feedback messages received from the second device.
